(19) United States
(12) Patent Application Publication
(10) Pub. No.: US 2019/0138953 A1
(43) Pub. Date: May 9, 2019

(54) Vehicle Test Drive Management Platform

(71) Applicants: Jimmy Caudillo, Murrieta, CA (US); Sebastian Flores, Murrieta, CA (US)

(72) Inventors: Jimmy Caudillo, Murrieta, CA (US); Sebastian Flores, Murrieta, CA (US)

(21) Appl. No.: 16/169,702

(22) Filed: Oct. 24, 2018

Related U.S. Application Data
(60) Provisional application No. 62/576,866, filed on Oct. 25, 2017.

(51) Int. Cl. G06Q 10/02; G06Q 50/30; G08G 1/00; G06Q 30/06

(52) U.S. Cl. CPC G06Q 10/02; G06Q 30/0623; G08G 1/202; G06Q 50/30

(57) ABSTRACT

A vehicle test drive system is disclosed, which allows a dealership's customers to test drive vehicles without travelling to the dealership. A customer interface allows a customer to request a test drive, which is approved or denied by the dealership. A sales agent then brings the requested vehicle to the customer's location, where the sales agent accompanies the customer on a test drive and tracks the vehicle's location through a mobile app. Support for groups of associated dealerships, such as a parent dealership with multiple child dealerships, is provided through a mult-tier account system including roles for managers and sales agents.

### RELATED APPLICATION

This application claims priority to the United States Provisional patent application for a “Vehicle Test Drive Management Platform,” Ser. No. 62/576,866, filed Oct. 25, 2017, and currently co-pending.

### FIELD OF THE INVENTION

The present application pertains generally to a platform for managing vehicle purchases. More specifically, the present application pertains to a platform which facilitates the delivery and tracking of vehicles to a dealership's customers for test driving. The disclosed innovations are particularly, but not exclusively, useful as a system for test driving vehicles without travelling to a dealership.

### BACKGROUND

The process of buying a car generally involves travelling to a dealership, test driving one or more cars, and determining whether to purchase one of the tested cars.

From a dealer's perspective, it is important not only to impress the customer with the car itself, but to provide a good impression of the dealership and its customer service overall. A dealer's livelihood may depend on the customer returning for vehicle maintenance and future purchases, and word-of-mouth recommendations from satisfied customers.

The traditional dealership model is centered on a car lot to which the customer travels to test drive and purchase a vehicle. This places the customer on the dealer's “home territory,” which may in some cases facilitate closing a sale, but may also leave the customer feeling vulnerable or uncomfortable, resulting in a less than optimal customer experience.

In light of the above, it would be advantageous to provide a system that allows dealers to efficiently provide all or part of a vehicle purchasing experience at a location comfortable to a customer.

It would be further advantageous to provide a platform which facilitates vehicle test driving at a customer's home, office, or other convenient location.

### SUMMARY

A platform for managing vehicle test drives comprises one or more servers with a customer interface, a dealer manager interface, a dealer agent interface, and one or more databases. The databases comprise customer, dealer's manager, and dealer's agent profile information, an inventory of cars, test drive requests made by customers, and a history of test drives linked to the customer performing each test drive and the vehicle driven.

In use, a customer requests a test drive through the customer interface. The dealer manager interface presents the request to a dealer's manager who approves or denies it. If the request is approved, the dealer agent interface presents it to a dealer's sales agent who confirms the approval and delivers the requested vehicle to the customer for a test drive. The dealer's sales agent accompanies the customer on the test drive and provides regular location updates to track the vehicle.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 illustrates a preferred embodiment of a vehicle test drive management platform;

FIG. 2 illustrates the interaction between a dealer's manager and a preferred embodiment of the vehicle test drive management platform;

FIG. 3 illustrates the interaction between a dealer's sales agent and a preferred embodiment of the vehicle test drive management platform;

FIG. 4 illustrates the interaction between a customer and a preferred embodiment of the vehicle test drive management platform; and

FIG. 5 illustrates the interaction of a preferred embodiment of the vehicle test drive management platform with a customer, a dealer's manager, and a dealer's sales agent in the process of providing and tracking a test drive vehicle to the customer.

### DETAILED DESCRIPTION

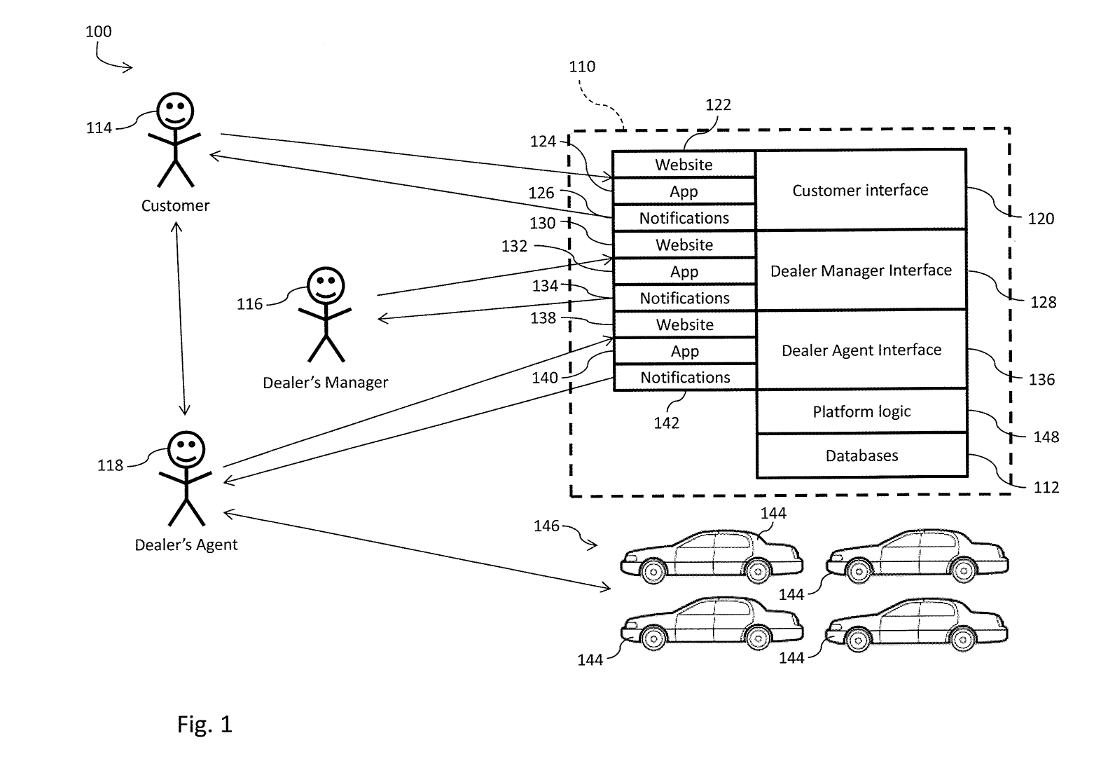

Referring initially to FIG. 1, a preferred embodiment of a vehicle test drive management platform is illustrated in general terms and generally designated 100. Platform 100 comprises a server 110 with one or more databases 112. Databases 112 store vehicle and customer information for retrieval and communication to customers 114, dealer's managers 116, and dealer's agents 118. Communication between the platform 100 and a customer 114 is performed through a customer interface 120 on the server 110. The customer 114 engages the customer interface 120 through a website 122 or a software program (“app”) 124 such as a mobile app. The customer interface 120 provides an immediate response through the website 122 or app 124, but an additional response may be required at a later time. For example, if the customer 114 requests, through the customer interface 120, to test drive a vehicle, the website 122 or app 124 will immediately respond that the request has been received. The request would then be forwarded to the dealership, e.g. to a dealer's manager 116, for approval. Upon approval or denial the customer 114 would need to be notified. The customer interface 120 has a notifications system 126 for providing notifications to the customer 114. A preferred embodiment of the notification system 126 is capable of sending notifications through email, SMS, and push notification systems. The customer 114 may receive a notification through one or more of email, SMS, and push notifications depending on the customer's preferred method of interaction with the platform 100. For example, if the customer 114 interacts with the platform 100 through a mobile app, and has registered both an email address and a mobile phone number with the platform 100, the customer interface 120 may send each notification to the customer 114 through an email, an SMS message, and a push notification. If a customer 114 has never interacted with the platform 100 through a mobile device, e.g. the customer 114 always uses a web browser, and the customer has never provided a mobile phone number to the dealership, the customer interface 120 will not send an SMS notification to the customer 114, but may send both an email and a push notification to the customer 114 if the customer 114 has registered an email address and accepted push notifications in the customer's browser; if the customer 114 has only registered or accepted one or the other, the customer interface 120 will only send the type of notification corresponding to what the customer 114 desires to receive.

In a preferred embodiment, notifications to a customer 114 will also be shown on a “dashboard” interface the next time the customer 114 engages the customer interface 120 through a website 122 or an app 124.

A dealer manager interface 128 enables dealer's managers 116 to interact with the platform 100. A dealer's manager 116 engages the dealer manager interface 128 through a website 130 or a software program (“app”) 132 such as a mobile application. The website 130 and app 132 provide immediate responses, and a notifications system 134, functioning in the same manner as notification system 126, provides later additional notifications to the dealer's manager 116. The notifications system 134 may provide a notification to a dealer's manager 116 when a customer 114 makes a request to test drive a car. The dealer's manager 116 would then review the request and approve or deny the request through the dealer manager interface 128.

A dealer agent interface 136 enables dealer's agents 118 to interact with the platform 100. A dealer's agent 118 engages the dealer agent interface 136 through a website 138 or a software program (“app”) 140 such as a mobile application. The website 138 and app 140 provide immediate responses, and a notifications system 142, functioning in the same manner as notification system 126, provides later additional notifications to the dealer's agent 118. The notifications system 142 may provide a notification to a dealer's agent 118 when a dealer's manager 116 approves the request of a customer 114 to test drive a car. The dealer's agent 118 would then deliver a vehicle 144 of the make, model, and year requested by the customer 114 from the dealer's inventory 146 to the customer 114 for a test drive. A preferred embodiment of the dealer's agent's app 140 is a mobile app configured to track the location of the vehicle 144 as the dealer's agent 118 accompanies the customer 114 on a test drive. The app 140 then provides the distance traveled, travel time, and route taken to the server 110 through the dealer agent interface 136, which then stores the information in the database or databases 112 and links it with the vehicle 144 and the customer 114 in such a manner that the dealer's agent 118, dealer's manager 116, and customer 114 can later view the vehicles 144 that the customer 114 has taken for test drives, and the distance and time travelled in each.

In a preferred embodiment of the platform 100, a single website is used for website 122, website 130, and website 138, and a single app for each supported operating system is used for app 124, app 132, and app 140. The website and app distinguish between a customer 114, a dealer's manager 116, and a dealer's agent 118 based on a profile associated with login credentials and display the appropriate interface or interface elements accordingly.

In another embodiment, a single website is used for website 130 and website 138, and a single app for each supported operating system is used for app 132 and app 140. The website and app distinguish between a dealer's manager 116 and a dealer's agent 118 based on a profile associated with login credentials and display the appropriate interface elements accordingly.

A platform logic module 148, comprising a variety of subroutines implementing the various rules and procedures of the platform 110, interacts with the customer interface 120, dealer manager interface 128, and dealer agent interface 136 to provide notifications and receive requests, status updates, and other instructions. In a preferred embodiment, the platform logic module 148 performs additional tasks to verify customer data, verify customer eligibility for financing, and further interact with the customer interface 120 to perform processes allowing a customer 114 to engage in all the steps of an automobile purchase through the platform 100, including the test drive, financing, and finalizing the purchase.

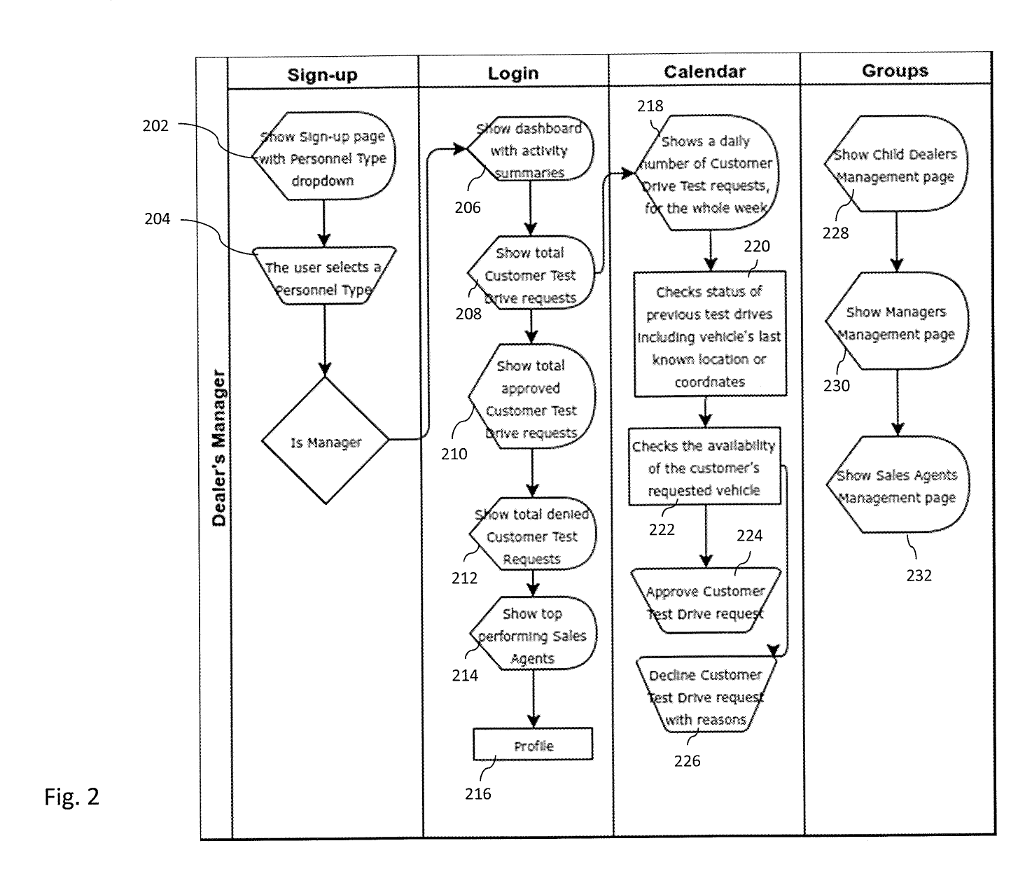

Referring now to FIG. 2, the interaction between a dealer's manager 116 and the platform 100 through the dealer manager interface 128 is shown. Initially, and account must be set up for the dealer's manager 116, which results in the creation of one or more rows in one or more database tables which stores credential and profile data associated with the account. An account creation page 202 facilitates the creation of an account for the dealer's manager 116. The account creation page 202 may be accessible from the dealer manager interface 128, through the website 130 and app 132 in order to allow a new dealer's manager 116 to set up his or her own account. Security features, such as the requirement to enter a code or password provided by the dealership may be used to prevent the creation of spurious or unauthorized accounts. Alternatively, the account creation page 202 may be accessed through an administrator interface available to authorized persons, such as a human resources manager. In the latter case, an authorized person such as a human resources manager would create the account for the dealer's manager 116.

In a preferred embodiment, the account creation page 202 includes a personnel type selection 204, which is a user interface feature configured for the selection of a personnel type. The personnel type selection 204 allows the selection of a personnel type from a list of options comprising dealer's manager and dealer's sales agent. The personnel type selection 204 thus allows the creation of accounts for dealer's managers 116 and dealer's agents 118 from the same account creation page 202.

Once an account is created, the dealer's manager 116 can log in. After logging in, the website 130 or app 132 presents a dashboard interface (“dashboard”) 206. A preferred embodiment of the dashboard 206 shows customer test drive requests 208 within a certain time period, approved customer test drive requests 210 for the time period, denied customer test drive requests 212 for the time period, and a list 214 of top performing dealer's agents 118. The dealer's manager 116 can also access his or her profile information 216, and in some embodiments is able to update a portion of that information.

In preferred embodiments a user interface element is provided which can be engaged by the dealer's manager 116 in order to set the time period for the shown customer test drive requests 208, approved customer test drive requests 210, and denied customer test drive requests 212 to a desired day, week, or month.

A user interface element on the dashboard 206 and, in some embodiments, associated with the customer test drive requests 208, can be engaged by the dealer's manager 116 in order to display a calendar interface 218 which shows the test drive requests for a selected week. In a preferred embodiment, the calendar interface 218 shows the week's test drive requests broken down by day. From the calendar interface 218, the dealer's manager 116 is able to check the status 220 of previous test drives and look up a vehicle's location, check the availability 222 of a vehicle matching the make, model, and any other details of a customer test drive request, and approve 224 or deny 226 a customer test drive request. In some embodiments, the customer 114 whose request is declined is provided with a reason for the denial of the test drive request. The reasons for denying a test drive request include the unavailability of a vehicle matching the request, the distance from the dealership to the customer 114, and other reasons such as a history of poor interactions between the customer 114 and dealer's agents 118. Approval 224 and denial 226 of a test drive request are performed through the engagement of one or more user interface elements provided through the calendar interface 218. Associated with the approval 224 of a test drive request in some embodiments is a user interface element which is engaged by the dealer's manager 116 in order to assign the approved test drive request to a dealer's agent 118. In other embodiments, the assignment is performed by the platform 100 automatically based on the workload and schedule of each available dealer's agent 118. In some embodiments, the platform 100 assigns an available dealer's agent 118 based on workloads and schedules, but the dealer's manager 116 is able to assign the test drive request to another dealer's agent 118 by engaging a user interface element directed to that purpose.

A preferred embodiment of the platform 100 supports the management of test drive requests and responses among a group of associated dealerships under a “parent” dealership. A child dealership management page 228, comprises an interface for management of individual dealerships acting under the parent dealership. The child dealership management page 228 allows for the addition and removal of child dealerships, as well as access to subordinate interfaces corresponding to each child dealership, including a managers management page 230 and a sales agents management page 232. The managers management page 230 allows for the viewing, addition, and removal of dealer's manager accounts associated with the selected child dealership in the platform 100. The sales agents management page 232 allows for the viewing, addition, and removal of dealer's agent accounts associated with the selected child dealership in the platform 100. In some embodiments, the managers management page 230 and the sales agents management page 232 are not associated with a specific child dealership, but show the managers and sales agents, respectively, across all associated dealerships. Other embodiments include a managers management page 230 and a sales management page 232 corresponding to each child dealership in addition to a managers management page 230 and a sales management page 232 which show the managers and sales agents, respectively, across all associated dealerships.

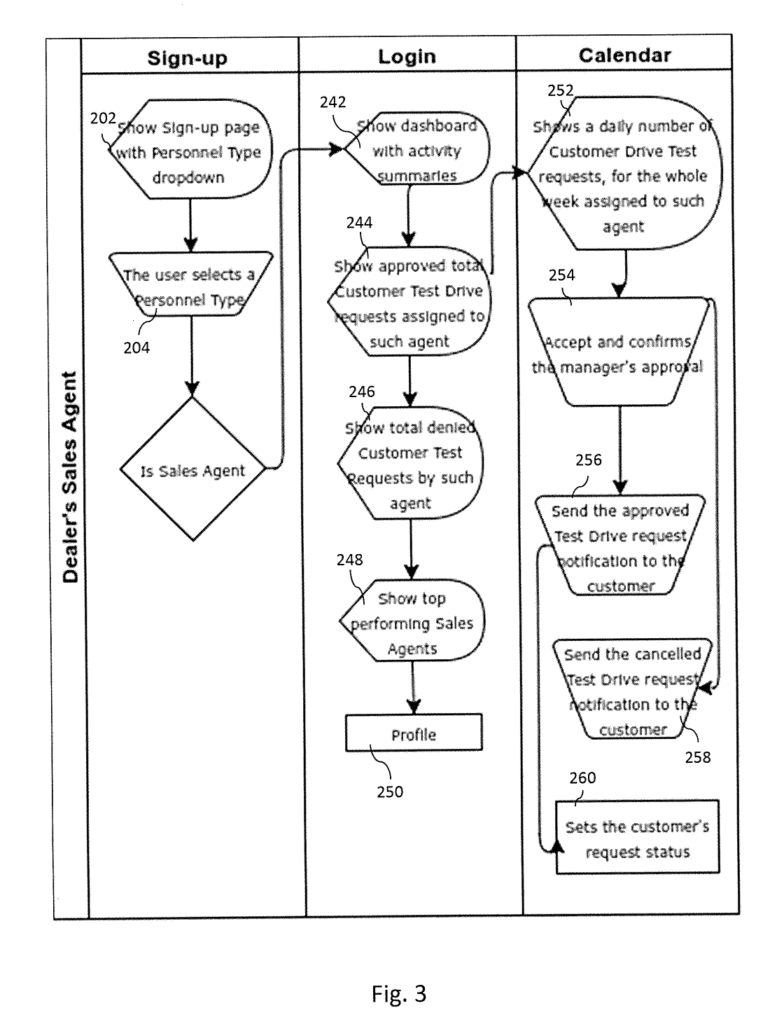

Referring now to FIG. 3, the interaction between a dealer's agent 118 and the platform 100 through the dealer agent interface 136 is shown. Initially, and account must be set up for the dealer's agent 118, which results in the creation of one or more rows in one or more database tables which stores credential and profile data associated with the account. An account creation page 202 facilitates the creation of an account for the dealer's agent 118. The account creation page 202 may be accessible from the dealer agent interface 136, through the website 138 and app 140 in order to allow a new dealer's agent 118 to set up his or her own account. Security features, such as the requirement to enter a code or password provided by the dealership may be used to prevent the creation of spurious or unauthorized accounts. Alternatively, the account creation page 202 may be accessed through an administrator interface available to authorized persons, such as a dealer's manager 116 human resources manager. In the latter case, an authorized person such as a dealer's manager 116 or a human resources manager would create the account for the dealer's agent 118.

In a preferred embodiment, the account creation page 202 includes a personnel type selection 204, which is a user interface feature configured for the selection of a personnel type. The personnel type selection 204 allows the selection of a personnel type from a list of options comprising dealer's manager and dealer's sales agent. The personnel type selection 204 thus allows the creation of accounts for dealer's managers 116 and dealer's agents 118 from the same account creation page 202.

Once an account is created, the dealer's agent 118 can log in. After logging in, the website 138 or app 140 presents a dashboard interface (“dashboard”) 242. The dashboard 242 shows the approved customer test drive requests 244 assigned to the dealer's agent 118 and the denied customer test drive requests 246 that were denied by the dealer's agent 118. As with the dealer's manager dashboard 206, a preferred embodiment of the dealer's agent dashboard 242 limits the display of approved and denied customer test drive requests to a predetermined time period that may be changed by the dealer's agent 118 through the engagement of a user interface element on the dashboard 242. In order to promote competition among dealer's agents 118 and drive sales, some embodiments also display a list of top performing agents 248 on the dashboard. In some embodiments, the list of top performing agents 248 includes sales figures for each top performing agent listed. The dealer's agent 118 can also access his or her profile information 250, and in some embodiments is able to update a portion of that information.

A user interface element on the dashboard 242 and, in some embodiments, associated with the approve test drive requests 244 assigned to the dealer's agent 118, can be engaged by the dealer's agent 118 in order to display a calendar interface 252 which shows the test drive requests assigned to the dealer's agent 118 for a selected week. In a preferred embodiment, the calendar interface 252 shows the week's test drive requests broken down by day. In a preferred embodiment, after a test drive request is approved by a dealer's manager 116 and assigned to a dealer's agent 118, the dealer's agent 118 then approves 254 or denies the test drive request from the calendar interface 252. When the dealer's agent 118 confirms the approval of the dealer's manager 116 by approving 254 the request, a notification 256 of the approval is sent to the customer 114 through the notification system 126 of the customer interface 120. If the dealer's agent 118 denies the request, a notification 258 of the denial is sent to the customer 114 through the notification system 126. When the test drive is complete, the dealer's agent engages user interface elements to set the test drive request status 260 as complete and enter notes and customer comments.

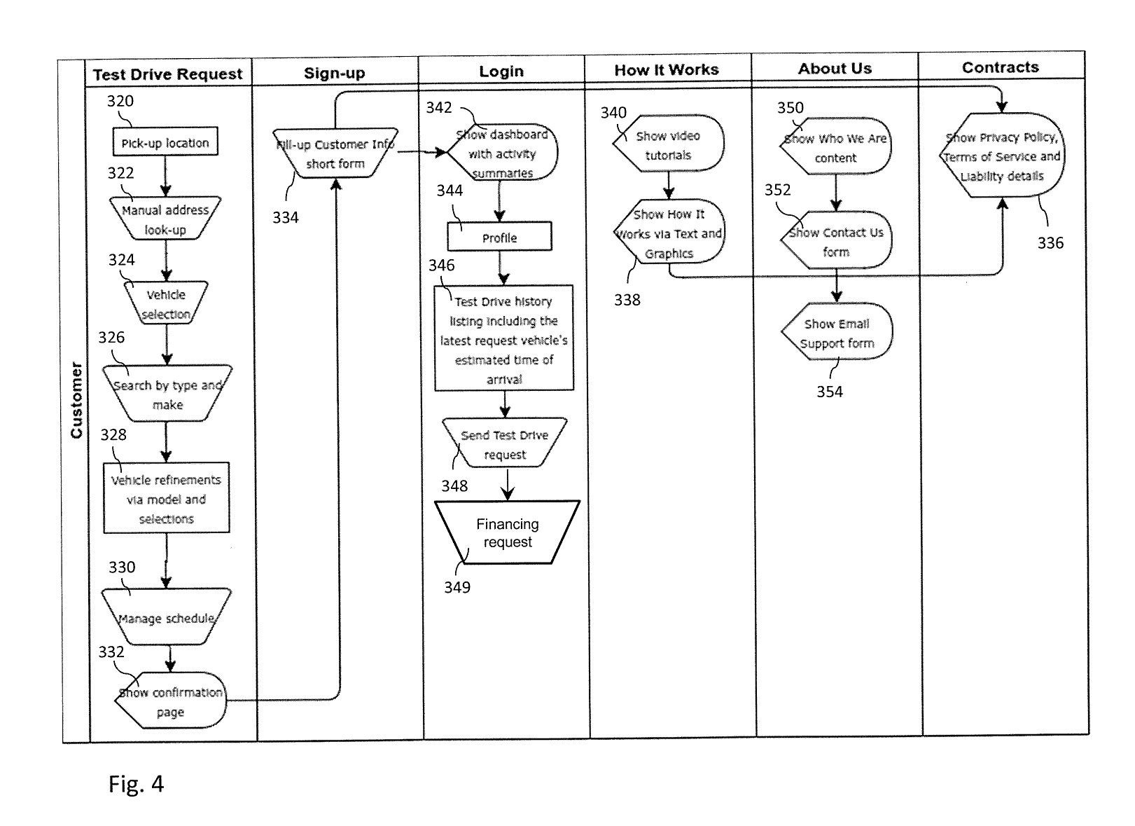

Referring now to FIG. 4, the interaction between a customer 114 and the platform 100 through the customer interface 120 is illustrated. The customer 114 engages the customer interface 120 either through a website 122 or app 124, both of which provide essentially the same functionality and differ primarily in presentation.

A customer 114 can engage the customer interface 120 to make a test drive request. The customer 114 engages a user interface element to enter or confirm a pick-up location 320 where the test drive will take place. When the necessary hardware is available, for example, when the customer is using an app 124 on a mobile phone, the location of the customer 114 is determined automatically—unless the customer 114 has turned off the feature—and used as a default pick-up location 320, which the customer 114 can then confirm or change through the aforementioned user interface element. In preferred embodiments, automatic determination of the location of the customer 114 is performed through one or more of GPS, A-GPS, cell-site multilateration, and Wi-Fi positioning.

Automatic determination of the location of a customer 114 may be unavailable in some circumstances, or an automatically determined pick-up location 320 may sometimes be inaccurate. A customer 114 may also desire a pick-up location that differs from the present location of the customer 114. In order to provide flexibility for such circumstances, the customer 114 may engage a user interface element to enter an address 322 to set as the pick-up location 320.

The customer 114 also engages a vehicle selection interface 324 in order to select the desired vehicle for a test drive. Within the vehicle selection interface 324, the customer 114 engages interface elements 326 to search by vehicle type, such as van, pickup truck, or sedan, and make. The customer 114 may decide to search by either type or make alone, or by both. The customer 114 then engages additional interface elements 328 to select a particular model and desired features.

A preferred embodiment of the platform 100, when in use with a group of associated dealerships, assigns the request to a particular dealer based on pick-up location and the make and model of the requested vehicle. The test drive request is assigned to the nearest dealership of the group which has in inventory a vehicle matching the request. Once a dealer is determined, the customer chooses a date and time for the test drive from options provided by the platform 100 based on the dealership schedule 330.

A preferred embodiment shows a confirmation page 332 allowing the customer 114 to review and confirm the details of the request, including the pick-up location 320, the vehicle specifications, and the scheduled date and time. If the customer 114 has previously created an account on the platform 100 and is logged in, the dealer is then notified of the test drive request, usually by a notification sent to the appropriate dealer's manager 116 through the notifications system 134. If the customer 114 is not logged in, the customer interface 120, particularly the website 122 or app 124, presents the customer an interface with options for logging in and signing up. The dealer is notified of the test drive request once the login process is complete.

The customer 114 may have “signed up,” or created an account on the platform 100, prior to the test drive request, either through his or her own volition by engaging associated user interface elements, or because the customer 114 has previously made test drive requests. However, if no account has been previously created for the customer 114, the customer signs up by filling out a short form 334 which requests information about the customer. When the form 334 is completed, a preferred embodiment of the platform 100 displays legal information 336 such as the privacy policy, terms of service, and liability details for the customer 114 to accept. When the sign-up process is complete, one or more rows are created in one or more database tables to create an account for the customer 114 and store profile and credential information. In a preferred embodiment, the customer 114 is then directed to information about using the platform 100, such as introductory or help pages 338 which use text and graphics, video tutorials 340, or both.

After logging in, the customer 114 is presented with a dashboard interface (“dashboard”) 342 containing a summary of the activity of the customer 114, such as past and scheduled test drives. User interface elements on the dashboard 342 can be engaged by the customer 114 to view and edit the profile 344 of the customer, review test drive history 346 in greater detail, including scheduled test drives with estimated arrival times, and to create a new test drive request 348 through the process described above.

The customer 114 may engage a user interface element 349 on preferred embodiments of the dashboard 342 to request financing and finalize the purchase of an automobile. If the customer 114 engages the financing request element 349, the customer 114 is provided the opportunity to enter his or her financial information, which is then verified by the platform logic 148, which determines whether an immediate financing approval is appropriate, and what the terms will be. If so, then the customer 114 is shown the terms and guided through the steps of finalizing a purchase of the desired automobile. Since the interface element 349 is accessible to the user from the dashboard 342, some embodiments of the platform 100 are flexible in the timing, allowing the customer 114 to request financing before or at the time of a test drive request, or at any time thereafter.

The customer 114 may also engage a user interface element on the dashboard 342, and, in preferred embodiments, available on the sign-up interface and elsewhere, to view information about the dealer and the platform. The information generally includes an overall description of the dealership 350, contact information 352, and a user interface element which can be engaged by the customer to send a support request through email 354.

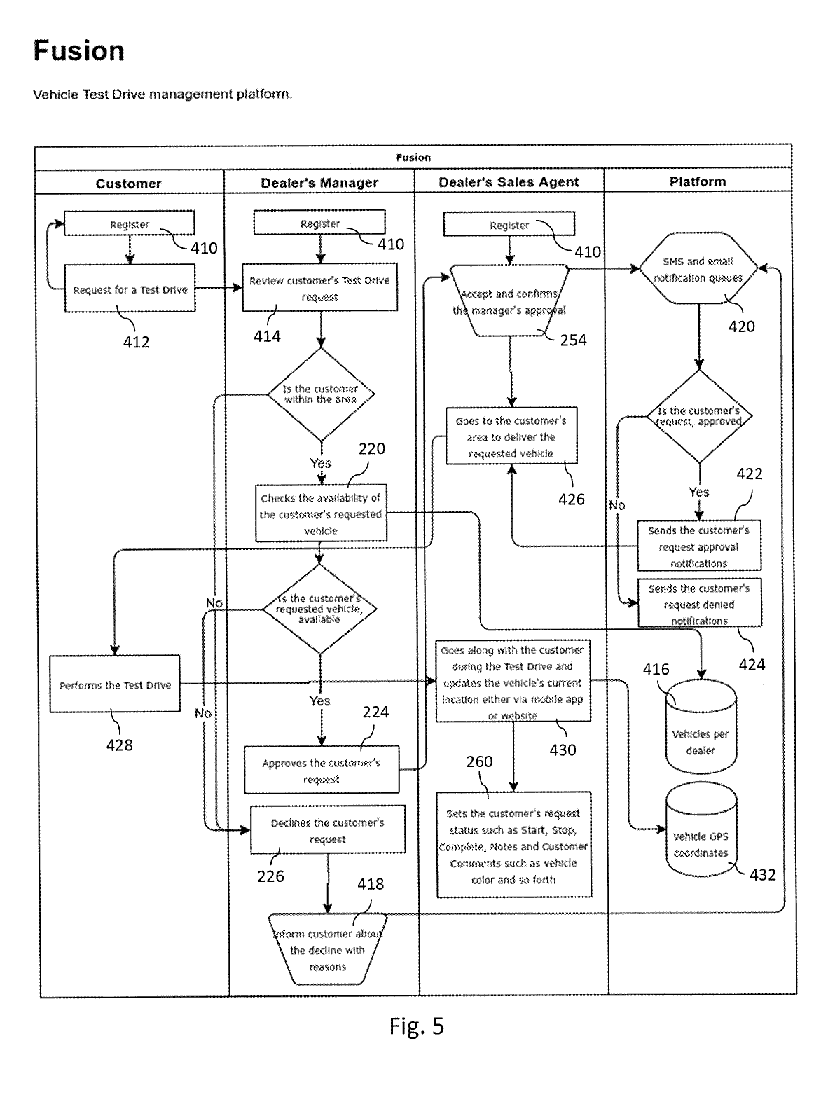

Referring now to FIG. 5, the process of requesting and performing a test drive as facilitated by the platform 100 is illustrated. A customer 114 creates a test drive request, which is assigned to a dealer's manager 116 for review and a dealer's sales agent 118 for vehicle delivery and interaction with the customer 114. The customer 114, dealer's manager 116, and dealer's sales agent 118 must all have accounts created (or “registered”) 410 on the server 110 prior to engaging the platform 100, with the exception that the customer 114 may register an account at the end of creating a test drive request 412 prior to the request being sent to the dealer's manager 116.

The dealer's manager 116 reviews the test drive request created by the customer 114. If the customer 114, or, in a preferred embodiment, the pick-up location 320, is out of a predetermined area near the dealership, or if a vehicle matching the request is unavailable, the dealer's manager 116 denies 226 the test drive request. Otherwise, unless other reasons for denying the request exist, the dealer's manager approves 224 the request. The dealer manager interface 128 provides vehicle availability information from a database 112 containing vehicle inventory 146 information, including the location of each vehicle 144.

If the test drive request is denied, the dealer's manager provides the reasons 418 for the denial, which form part of a notification of the denial that is sent to the notifications system 126 to be sent to the customer 114. The notification is initially placed in a notification queue 422. The notifications system 126 retrieves approval notifications 422 and denial notifications 424 from the queue and sends them to the customer 114 who made the request.

The dealer's agent 118 then approves 254 the request, and a notification of the approval is placed in the notification queue 420 to be processed by the notifications system 126 and sent to the customer 114. On the scheduled date and within the selected time slot, the dealer's sales agent 118 delivers 426 the requested vehicle to the pick-up location 320. The customer 114 meets the dealer's sales agent 118 at the pick-up location 320 and performs the test drive 428. The dealer's sales agent 118 accompanies the customer on the test drive and tracks the vehicle's location 430. In preferred embodiments, the dealer's agent 118 uses app 140 installed on a mobile device to perform the tracking. App 140 automatically retrieves GPS coordinates 432 on a substantially continuous basis throughout the test drive, which are stored in a database 112.

Before, during, and after the test drive, the dealer's agent 118 updates the test drive request status 260 through the dealer agent interface 136. In a preferred embodiment, the app 140 automatically starts tracking the vehicle when the status 260 is set to “start,” and stops tracking when the status is set to “stop” or “complete.” Along with the status 260, the dealer's agent 118 records notes and customer comments through the dealer agent interface 136 which are then stored in a database 112.

While there have been shown what are presently considered to be preferred embodiments of the present invention, it will be apparent to those skilled in the art that various changes and modifications can be made herein without departing from the scope and spirit of the invention.

What is claimed is:

1. A vehicle test drive management platform, comprising:
at least one server, comprising:
a database,
a customer interface,
a dealer manager interface, and
a dealer agent interface; and
a dealership comprising a plurality of vehicles,
wherein the customer interface is operable by a customer to generate a request to test drive a vehicle from said plurality of vehicles.

2. The vehicle test drive management platform as recited in claim 1, further comprising a dealer manager notification system configured to notify a dealer of test drive requests generated by customers, and wherein the dealer manager interface is operable by the dealer to approve or deny the test drive requests individually.

3. The vehicle test drive management platform as recited in claim 2, further comprising a dealer agent notification system configured to notify a dealer agent of test drive requests approved by the dealer manager.

4. The vehicle test drive management platform as recited in claim 1, wherein the customer interface comprises a website.

5. The vehicle test drive management platform as recited in claim 1, wherein the customer interface comprises a mobile app.

6. The vehicle test drive management platform as recited in claim 1, wherein the customer interface comprises a website and a mobile app.

7. The vehicle test drive management platform as recited in claim 1, further comprising:
a child dealership management interface;
a child dealership; and
a subordinate interface for the child dealership.

8. The vehicle test drive management platform as recited in claim 7, wherein the child dealership management interface is operable by the dealer to add and remove child dealerships.

9. The vehicle test drive management platform as recited in claim 1, wherein the customer interface comprises a user interface element operable by the customer to request financing and purchase an automobile.

10. A vehicle test drive management platform, comprising:
a database;
platform logic;
a dealer manager interface;
a dealer agent interface;
a customer interface; and
one or more vehicles,
wherein the customer interface is operable by a customer to generate a request to test drive a vehicle of the one or more vehicles,
wherein the dealer manager interface is operable by a manager to approve or deny requests to test drive a vehicle of the one or more vehicles, and
wherein the dealer agent interface is operable by an agent to view approved requests to test drive a vehicle of the one or more vehicles.

11. The vehicle test drive management platform of claim 10, wherein the customer interface comprises a notification system configured to send a notification to the customer when the request generated by the customer to test drive a vehicle of the one or more vehicles is approved or denied.

12. The vehicle test drive management platform of claim 11, wherein the notification comprises one or more notification types selected from the group consisting of email notifications, SMS notifications, and push notifications.

13. The vehicle test drive management platform of claim 10, wherein the customer interface is operable by the customer to generate a request for financing to purchase a vehicle, the request for financing comprising customer financial information.

14. The vehicle test drive management platform of claim 13, wherein the platform logic is configured to verify the customer financial information and determine whether to immediately approve financing.

15. The vehicle test drive management platform of claim 10, wherein the request generated by the customer to test drive a vehicle of the one or more vehicles comprises a vehicle pick-up location.

16. The vehicle test drive management platform of claim 15, wherein the customer interface is configured to determine the location of the customer and use the determined location as a default vehicle pick-up location.

17. A vehicle test drive and purchasing management platform, comprising:
a customer interface, comprising:
a website,
a mobile app, and
a notification system; and
platform logic,
wherein the customer interface is operable by a customer to request to test drive a vehicle, to request financing to purchase a vehicle, and to purchase a vehicle,
wherein the notification system is configured to notify the customer of an approval or a denial of the customer's request to test drive a vehicle, and
wherein the platform logic is configured to approve or deny immediate financing to purchase a vehicle in response to the customer's request for financing.

18. The vehicle test drive and purchasing management platform as recited in claim 17, wherein the customer's request to test drive a vehicle comprises a pick-up location.

19. The vehicle test drive and purchasing management platform as recited in claim 18, wherein the pick-up location is automatically determined by the mobile app through A-GPS positioning.

20. The vehicle test drive and purchasing management platform as recited in claim 18, wherein the platform logic is configured to assign the customer's request to test drive a vehicle to a dealership based on the pick-up location.
